(19) United States
(12) Patent Application Publication
(10) Pub. No.: US 2014/0145003 A1
(43) Pub. Date: May 29, 2014

(54) COLOR APPLICATION SYSTEM AND METHOD FOR OPERATING THE SAME

(71) Applicants: Ewald Schmon, Grafenberg (DE); Peter Dettlaff, Remseck (DE)

(72) Inventors: Ewald Schmon, Grafenberg (DE); Peter Dettlaff, Remseck (DE)

(73) Assignee: SATA GMBH & CO. KG, Kornwestheim (DE)

(21) Appl. No.: 13/879,166

(22) PCT Filed: Sep. 26, 2011
(86) PCT No.: PCT/EP2011/066665

§ 371 Date: Jun. 28, 2013

(30) Foreign Application Priority Data
Oct. 20, 2010 (DE) 10 2010 060 086.5

(51) Int. Cl. B05B 12/00

(52) U.S. Cl. CPC B05B 12/008
USPC 239/8; 239/71

(57) ABSTRACT

A color application system and method provide improved results of the color application and the operation of the color application system, for example color application errors due to varying pressure are reduced or eliminated, by using a color application system having one or more receivers for wireless data transfer between components of the color application system, wherein one of the components is a color sprayer having a detecting unit for detecting operating parameters of the color sprayer and/or environmental parameters, and a transmitter for wirelessly transferring the operating parameters and/or environmental parameters to the receiver. In a method for operating such a color application system, the operating parameters of spray air pressure and/or optionally the pressure of the medium to be sprayed is detected in or at the color sprayer, and then the detected pressure or pressures are wirelessly transferred to one or more components of the color application system.

The invention concerns a color application system and a method for operating the same.

From DE 695 35 077 T2, a control system for a powder coating system is known. There, a communication network is provided, which connects control components of the powder coating system with powder sprayers, which spray powder coating materials on parts that are to be coated. The disadvantage there is that there is no monitoring of the pressure of the powder to be applied on the powder sprayers, but rather, the pressure is merely measured and adjusted, at a relatively far distance from the powder sprayers. A pressure fluctuation on the powder sprayers is, therefore, recognized only late and any application errors produced in this way are compensated for only poorly. In addition, in such a system, leakages in the supply lines or a clogging are not detected; an insufficient coating result is attained due to a decrease or increase in pressure. The long lines before the adjusting and measuring elements to the sprayer lead to inaccurate and delayed regulations and adjustments as a result of the relatively high volumes.

U.S. Pat. No. 5,443,642 concerns a system for electrostatic color coating, wherein the pressure there is measured via pressure sensors and the air humidity, via humidity sensors, which, however, are not directly located on a color sprayer. Rather, permanently installed spray heads are used there, with the workpiece moving past them.

Another electrostatic sprayer can be deduced from DE 34 02 945 C2, which has on it a voltage display with a display field pointing backwards. Dependent on the voltage on the sprayer, a light-emitting diode shines, so that changes in the voltage can be quickly detected.

Since, in contrast to powder coating systems with color sprayers and lacquer spray guns for liquid colors, the quality of the color application is decisively dependent on the atomization and thus on the pressure directly applied on the sprayer nozzle, the known powder coating system does not offer a sufficiently good solution for fluid-operated color sprayers. In particular, it is not possible there to measure directly the pressure on the sprayers and thus to promptly regulate them.

With known color sprayers or lacquer spray guns, in particular, for liquid media, such as paint, digital pressure measuring devices are used in the sprayer, wherein the tracking of the pressure on the color sprayer takes place either via manually adjustable throttles or via pressure regulators, which are located at a distance from the color sprayer. In order to change the pressure applied on the color sprayer, the pressure must be readjusted, via the throttle or the pressure regulator, until the desired pressure on the color sprayer is attained. This is susceptible to error, in particular if the environmental conditions change, for example, the pressure hose to the color sprayer is bent or has constrictions; the position of the color sprayer changes during the application of the color; other consumers are connected or disconnected, etc. The application result is influenced negatively by the pressure changes which thereby occur.

U.S. Pat. No. 5,381,962 discloses an example of such a color application system in the form of a sprayer and the transmitter located therein, for the wireless data transfer, with a receiver of a pump module. There, adjustments on the color sprayer can be undertaken with the aid of switches on the sprayer; these can then be transferred to the pump module. Thus, the pump module can be operated from the color sprayer, wherein this must always take place manually—that is, in a relatively slow and inaccurate manner.

Also, U.S. Pat. No. 4,614,300, which concerns an automatic color application system, merely discloses that a control and supply of mechanically moveable sprayers takes place. Data on the sprayers are neither detected nor sent back from there to the control of the color application system.

Therefore, the goal of the invention is to create a color application system and a method for its operation, in which the color application result and the operation of the color application system is improved and, in particular, color application errors caused by pressure fluctuations are reduced or entirely avoided.

This goal is attained by the invention with a color application system with the features of claim 1 and a method for its operation, with the features of claim 21. Advantageous developments and expedient refinements of the invention are indicated in the subclaims.

In this regard, the invention provides for a color application system with one or more receivers for wireless data transfer between components of the color application system, wherein one of the components is a color sprayer with a detection unit for the detection of operating parameters of the color sprayer and/or environmental parameters and a transmitter for the wireless transfer of the operating parameters and/or the environmental parameters to the receiver.

Furthermore, in this respect, the invention provides for a method for the operation of such a color application system, wherein the operating parameter spray air pressure and/or the pressure of the medium to be sprayed is detected on or in the color sprayer, and then, the detected pressure(s) or other operating or environmental parameters are transferred wirelessly to one or more components of the color application system.

In a preferred development of the invention, the transmitter of the color sprayer can be integrated, encapsulated, into the color sprayer. In this way, a penetration of the medium to be sprayed, as well as cleaning agents and solvents, into the sensitive electronics of the detection unit and the transmitter can be avoided.

In addition, the detection unit in or on the color sprayer can comprise one or more pressure detection devices for the detection of the operating parameters spray air pressure and/or the pressure of the medium to be sprayed and, optionally, other parameters. In this way, the pertinent pressure can be determined directly before the application site and then any deviation from the desired pressure or other parameters can be quickly readjusted, without the user having to activate the color sprayer. This is particularly advantageous in the case of only small pressure fluctuations, for example, by a brief position change of the sprayer or a bending or constricting of the supply hose for the spray compressed air or the medium to be applied.

Advantageously, the detection unit can comprise on or more measuring devices for the detection of the environmental parameters air pressure, air humidity, air speed, and/or ambient temperature, etc. In this way, it is possible to take into consideration such environmental parameters during the adjustment of the spray air pressure and/or the pressure of the medium to be applied, as well as other parameters.

Moreover, the color sprayer can be advantageously connected with a component of the color application system, designed as a compressed air provision, with a compressed air source and a compressed air regulator, for supplying with spray compressed air via a compressed air line. Thus, the detected spray air pressure can advantageously be transferred to the compressed air regulator of the compressed air supply and be compared there with a prespecified theoretical value of the spray air pressure, and the compressed air regulator can then adjust the pressure of the spray compressed air delivered to the color sprayer in such a way that the spray air pressure on the color sprayer is adapted to the theoretical value of the spray air pressure.

Likewise, additionally or alternatively, the color sprayer can be advantageously connected with a component of the color application system, designed as a medium supply, for provision with the medium to be sprayed via a medium supply line. In this way, the detected pressure of the medium to be sprayed can be advantageously transferred to the medium supply and there, compared with a prespecified theoretical value, and the medium supply can then adjust the pressure of the medium delivered to the color sprayer in such a way that the pressure of the medium to be sprayed on the color sprayer is adapted to the theoretical value.

In another advantageous development of the invention, the color application system can comprise, as an additional component, a control for the monitoring and/or control of the operating parameters of the color sprayer and other components of the color application system. Thus the detected pressure(s) can be advantageously transferred to the control; the detected pressure is compared, in the control, with a prespecified theoretical value of this pressure; and the control then manages the compressed air regulator and/or the medium provision in such a way that the pressure of the spray compressed air and/or the medium to be sprayed on the color sprayer is advantageously adapted to the prespecified theoretical value.

In an advantageous, user-friendly embodiment, a display unit to indicate the operating parameters and/or the environmental parameters, detected by the detection unit, is provided as an additional component of the color application system. With this, the detected operating parameters and/or environmental parameters, and in particular, the detected pressure(s) is/are transferred to the display unit so they can be indicated. In another development, an indication can be shown on the display unit, if a prespecified value for the spray air pressure and/or the pressure of the medium to be sprayed, adjusted on the color sprayer or the operating unit, exceeds or falls short of the maximum pressure that can be made available. In this way, the user of the color sprayer can quickly be made aware when the pressure was not automatically adjusted or insufficient operating conditions prevail.

Preferably, the display unit can be placed on the site of the medium application, in particular, in a spray booth. Alternatively, the display unit can be located on the color sprayer. In addition, alternatively, the display unit can be transportable, and in particular, it can be designed in the form of a display unit that can be affixed to the wrist of an operator of the color sprayer. It is also conceivable to equip a traditional wristwatch or pocket watch with such a display unit as an additional function. All these variants have the advantage that the user can recall the indicated data, quickly and directly, during the application and not have to go to a remote place, as with known devices in which a display, in particular, of pressure parameters regularly takes place at the pressure supply or control that is more or less far removed from the application site.

In an advantageous refinement, the color application system can comprise, as an additional component, an operating unit for the modification of adjustment parameters of the color application system. The operating unit can be advantageously located, just like the display unit, on the color sprayer. In addition, alternatively, the operating unit can be transportable, just like the display unit, and in particular, it can be designed in the form of an operating unit that can be affixed on the wrist of an operator of the color sprayer. All these variants have the advantage that the user can modify and control adjustment parameters which have to be modified, for example, the desired spray air pressure, in a quick and direct manner, at the site of the color application, optionally even during the application itself, and he does not have to go to a remote place, as with known devices in which an operation is often possible only there.

Preferably, one or more of the components can have a receiver and/or transmitter for the wireless transmission of data. In this way, these components can advantageously transfer data directly to one another, so that, for example, a breakdown or error in the compressed air supply can be transferred directly to the display unit on the wrist of the user of the color sprayer and can trigger an alarm there, acoustically and/or visually. Furthermore, the wireless data transfer can be advantageously carried out bidirectionally, so that with a just described alarm with the user, he can directly send out, via an operating unit, a signal to the defective compressed air supply, for example, a stop signal for the immediate turning off of the compressed air supply.

Advantageously, the wireless data transfer can take place via radio, WLAN, DECT or Bluetooth, or other such media, so that already known, standardized transmitters and receivers can be used.

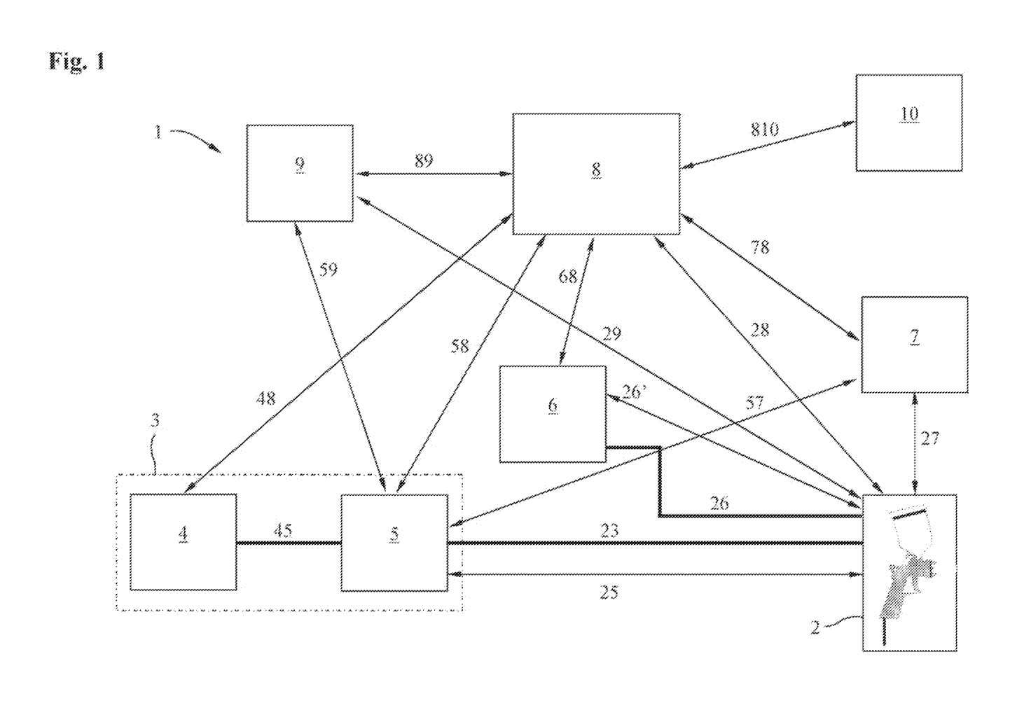

Other special features and advantages of the invention can be deduce from the following description of a preferred embodiment example with the aid of the drawing in FIG. 1

FIG. 1 shows a functional block diagram of a color application system 1, in accordance with the invention. In order to apply, as a medium, liquid color or lacquer on an object to be sprinkled or sprayed, a color sprayer 2, which is, in fact, known, with a pressure sensor, located in the color sprayer 2, preferably a digital pressure sensor as the detection unit for the operating parameters, spray air pressure and/or the pressure of the medium to be sprinkled or sprayed, is provided. In addition, the color sprayer 2 comprises a WLAN transmitter and a data processing unit, which prepares the detected operating parameters for the data transfer to the WLAN transmitter.

The color sprayer 2 is supplied, via a connection line 23, drawn thick, with spray compressed air—below, referred to also as compressed air—from a compressed air provision 3 (optionally also with compressed air preparation). In this respect, the compressed air provision 3 has a pressure source 4 and a pressure regulator 5. By means of the pressure regulator 5, it is possible to adjust the pressure in the connection line 23 to the color sprayer 2. In addition, the transmitter communicates with the pressure regulator 5 via a WLAN connection 25.

Here and below, thick connection lines mark conveyance lines, whereas the double arrows, drawn thin in FIG. 1, refer to the data communication.

Furthermore, the color sprayer 2 is connected, via a material supply line 26, with a medium provision for the liquid coating material, designed as a conveyance unit 6. On the other hand, the medium (the color or the lacquer) could also come via gravity, (overhead), suspension, or side cups into the color sprayer.

The color application system 1 is centrally controlled by a control unit 8, which, with all other depicted components of the color application system 1, is connected with WLAN connections to the wireless data transfer. Of course, other such connections can also be provided.

Another component of the color application system 1 is an operating unit 7, which is designed as a wrist computer. It can also be designed, however, as a transportable computer, which can be carried by the operator directly on his body or can be located in the vicinity of the site where the color is applied. Alternatively, the operating unit 7 can also be a remote service unit.

In addition, a display unit 9 is provided, which shows all essential data for the color spraying, for example, the values adjusted on the pressure provision 3 and/or the medium provision 6 and actually applied—also the detected operating parameters transferred by the color sprayer 2, etc. In this case, the display unit 9 is advantageously integrated with the operating unit 7 in the manual computer. However, it can also be situated in a stationary manner or it can be designed as a transportable display unit.

Here, the data communication is carried out completely via wireless WLAN connections, but it could also be operated via other suitable wireless connections, for example, Bluetooth. In addition, a combination of different connection possibilities, both wireless as well as cable-supported connections, are possible. However, it is advantageous if at least the color sprayer, the operating unit 7, and the display unit 9 communicate wirelessly with one another or with other components, in particular, the control unit 8.

A spray booth 10, in which the color application is carried out here with the color sprayer, is also connected with the control unit 8.

Particularly when using the color sprayer 2 in the spray booth 10, a wireless data transfer is advantageous, since then only the supply lines 23 and 26 for the spray compressed air and color have to be provided, whereas other connection lines for the transfer of data can be omitted.

As a result of these wireless connections with transmitting performances below the explosion limit values, a very high operating safety is guaranteed in the spray booth, which, as a rule, is constructed as an explosion-proof space. The expense for sufficient explosion protection measures is, in any case, reduced.

Moreover, in a preferred embodiment, the adjustment elements for the spray air pressure and/or optionally, the color pressure can be located on the color sprayer 2 itself or on the operating unit 7.

In the conveying unit 6, furthermore, sensors for the detection of the decisive conveyance data, for example, updated pressure, made available by the conveyance unit, a throughflow quantity of the conveyed material, etc., can be provided, which can transfer these and optionally other measurement parameters to the control unit 8 and/or the display unit 9.

Still other sensors are advantageously provided in the detection unit in the color sprayer 2, which can detect the humidity, temperature, air speed in the surroundings of the color sprayer 2. In addition, in an alternative embodiment, the display unit 9 can be located directly on the color sprayer 2, so as to be able to indicate the operating, environmental, and/or the adjustment parameters shown in the display unit 9 to the user of the color sprayer 2. Alternatively or additionally, the parameters detected by the color sprayer or its sensors can also be transferred to the display unit 9, the control unit 8, or the operating unit 7, where they are then clearly visible to the user.

Another advantage of the contactless transfer of data by the color sprayer 2 to the other components 3-10 of the color application system is that, in this way, implementations in the color sprayer 2, for example, to switches, external antennae, or externally running cables can be avoided. This is advantageous, since these sealings must, as a rule, be constructed solvent- and water-tight and, in addition, can easily suffer mechanical damage. This expense can be avoided by the use of the invention. Furthermore, as a result of the wireless data transfer—as already mentioned previously, the invention can be advantageously used, when utilizing the color sprayer 2, under complicated environmental conditions, for example, in areas endangered by explosions or under dusty conditions.

1. Color application system with one or more receivers for wireless data transfer between components of the color application system, wherein one of the components is a color sprayer with a detection unit for the detection of operating parameters of the color sprayer and/or environmental parameters and a transmitter for the wireless transfer of the operating parameters and/or environmental parameters to the receiver.

2. Color application system according to claim 1, wherein the transmitter of the color sprayer is integrated, encapsulated, into the color sprayer.

3. Color application system according to claim 1 wherein the detection unit in or on the color sprayer comprises one or more pressure detection devices for the detection of the operating parameters, spray air pressure and/or the pressure of the medium to be sprinkled.

4. Color application system according to claim 1, wherein the detection unit comprises one or more measurement devices for the detection of the environmental parameters, air pressure, air humidity, air speed, and/or environmental temperature.

5. Color application system according to claim 1, wherein the color sprayer is connected, via a compressed air line, with a component of the color application system, designed as a compressed air provision with a compressed air source and a compressed air regulator, for the provisioning with spray compressed air.

6. Color application system according to claim 1, wherein the color sprayer is connected, via a medium supply line, with a component of the color application system, designed as a medium provision, for the provisioning with the medium to be sprayed.

7. Color application system according to claim 1, wherein the color sprayer is provisioned with the medium to be sprayed, via gravity, (overhead), suspension, or side cups, or via hose lines.

8. Color application system according to claim 1, further comprising a control unit for the monitoring and/or control of the operating parameters of the color sprayer and other components of the color application system.

9. Color application system according to claim 1, further comprising a display unit for the display of the operating parameters and/or environmental parameters, detected by the detection unit.

10. Color application system according to claim 9, wherein the display unit is placed at the site of the medium application, in particular, in a spray booth.

11. Color application system according to claim 9, wherein the display unit is located on the color sprayer.

12. Color application system according to claim 9, wherein the display unit is transportable, and in particular, it is designed in the form of a display unit which can be affixed to the wrist of an operator of the color sprayer.

13. Color application system according to claim 1, further comprising an operating unit for the modification of the adjustment parameters of the color application system.

14. Color application system according to claim 13, wherein the operating unit is placed at the site of the medium application, in particular, in a spray booth.

15. Color application system according to claim 13, wherein the operating unit is located on the color sprayer.

16. Color application system according to claim 13, wherein the operating unit is transportable, and in particular, it is designed in the form of an operating unit that can be affixed to the wrist of an operator of the color sprayer.

17. Color application system according to claim 1, wherein one or more of the components have a receiver and/or transmitter for the wireless data transfer.

18. Color application system according to claim 17, wherein the components equipped with a receiver and/or transmitter, transfer data directly to one another.

19. Color application system according to claim 1, wherein the wireless data transfer takes place via radio, WLAN, optically, or Bluetooth, or via another wireless connection.

20. Color application system according to claim 1, wherein the wireless data transfer takes place bidirectionally.

21. Method for the operation of a color application system of claim 1, wherein the operating parameters, spray air pressure and/or optionally, the pressure of the medium to be sprinkled is detected on or in the color sprayer, and then the detected pressure(s) is/are transferred wirelessly to one or more components of the color application system.

22. Method according to claim 21, wherein the detected operating parameters and/or environmental parameters, and in particular, the detected pressure(s) are transferred to the display unit for their display.

23. Method according to claim 21, wherein the detected spray air pressure is transferred to the compressed air regulator of the compressed air provision; there, it is compared with a prespecified theoretical value of the spray air pressure; and the compressed air regulator then adjusts the pressure of the spray compressed air delivered to the color sprayer in such a way that the spray air pressure on the color sprayer is adapted to the theoretical value of the spray air pressure.

24. Method according to claim 21, wherein the detected pressure of the medium to be sprinkled is transferred to the medium provision; there, it is compared with a prespecified theoretical value; and the medium provision then readjusts the pressure of the medium delivered to the color sprayer (2) in such a way that the pressure of the medium to be sprinkled on the color sprayer is adapted to the theoretical value.

25. Method according to claim 21, wherein the detected pressure(s) is/are transferred to the control unit; in the control unit, the detected pressure is compared with a prespecified theoretical value for this pressure; and the control unit then controls the compressed air regulator and/or the medium provision in such a way that the pressure of the spray compressed air and/or optionally, of the medium to be sprinkled on the color sprayer is adapted to the prespecified theoretical value.

26. Method according to claim 21, wherein the display unit indicates if a prespecified value for the spray air pressure and/or the pressure of the medium to be sprinkled, adjusted on the color sprayer or the operating unit, exceeds a maximum pressure made available by the color application system.
